(19) United States
(12) Patent Application Publication
(10) Pub. No.: US 2025/0125391 A1
(43) Pub. Date: Apr. 17, 2025

(54) FIRE PROTECTION SYSTEM AND METHOD FOR REDUCING A FIRE HAZARD IN A PROTECTIVE SPACE

(71) Applicant: HY.AIR Energy GmbH, Hamburg (DE)

(72) Inventors: Lars FRAHM, Wismar (DE); Andreas EXLER, Hamburg (DE)

(21) Appl. No.: 18/911,463

(22) Filed: Oct. 10, 2024

(30) Foreign Application Priority Data
Oct. 11, 2023 (DE) 10 2023 209 957.8

(51) Int. Cl. H01M 8/0662; A62C 3/16; B01D 53/06; B01D 53/26; B01D 53/86; H01M 8/0438; H01M 8/04492; H01M 8/04746

(52) U.S. Cl. CPC H01M 8/0662; A62C 3/16; B01D 53/06; B01D 53/261; B01D 53/8671; H01M 8/0441; H01M 8/04522; H01M 8/04761; B01D 2257/108; H01M 2250/10; H01M 2250/20

(57) ABSTRACT

A fire-protection system (1) reduces a danger of fire in a protective space. The fire-protection system includes a fuel cell (3) with a cathode exhaust gas output (25) which is strictly separated from an anode output (27), for the provision of an oxygen-reduced cathode exhaust gas with an oxygen content of at the most 15.0% by volume at the cathode exhaust gas output, a drying system (35) which is connected downstream of the cathode exhaust gas output, for drying the oxygen-reduced cathode exhaust gas before the oxygen-reduced cathode exhaust gas is led into the protective space (54), and a control system (51) which is configured to determine a current dew point of the oxygen-reduced cathode exhaust gas which is dried by the drying system and to lead the dried, oxygen-reduced cathode exhaust gas into the protective space only when the current dew point lies below as settable maximal dew point.

### CROSS REFERENCE TO RELATED APPLICATIONS

This application claims the benefit of priority under 35 U.S.C. § 119 of German Application 2023 209 957.8, filed Oct. 11, 2023, the entire contents of which are incorporated herein by reference.

### TECHNICAL FIELD

The present invention relates to a fire-protection system and to a method for the reduction of the danger of fire in a protective space. Such a system and method can also be applied for combating fire or for assisting in such.

### BACKGROUND

It is known from DE 10 2005 053 692 B3 that the oxygen-reduced cathode exhaust gas of a fuel cell can be used for reducing the danger of fire in a space, for example in an aircraft. It has been found that such fire-protection systems with the use of an oxygen-reduced cathode exhaust gas of a fuel cell can be applied particularly well where conventional fire-protection systems such as water sprinklers cannot be applied. In particular, this relates to large-volume protective spaces with a volume of 100,000 m³ or more. In particular, partly automated or fully automated high-bay storage spaces with high packing densities cannot be provided with sprinkler facilities in order to effectively reduce the danger of fire. The same applies to deep-freeze storage spaces, in which water conduits would freeze. In archiving or server spaces, a fire-protection system on the basis of an oxygen-reduced cathode exhaust gas of a fuel cell can also be advantageous compared to conventional fire-protection systems.

However, a problem arises if a high quantity of humidity is led into the protective space by the oxygen-reduced cathode exhaust gas. In a deep-freeze storage space, the humidity often precipitates as snow or ice. In archiving systems, condensed moisture could also lead to the undesirable formation of mold. In automated high-bay storage spaces or server spaces, condensed moisture could undesirably lead to corrosion or short-circuits.

It is known from DE 10 2005 053 692 B3, to dry the water-containing oxygen-reduced cathode exhaust gas by way of a condenser and to use the condensed water for other purposes.

Herein however, it is not clear whether the oxygen-reduced cathode exhaust gas is dry enough or not for the application in the protective space.

### SUMMARY

It is therefore the object of the present invention to provide a fire-protection system and a method for the reduction of the danger of fire in a protective space, which ensures that the oxygen-reduced cathode exhaust gas is dry enough for the protective space depending on the application case.

This object is achieved by a fire-protection system and method for reducing the danger of fire in a protective space according to the invention. Preferred embodiments of the invention are to be derived from the claims, the description and the figures.

According to a first aspect of the present invention, a fire-protection system for the reduction of a danger of fire in a protective space is provided, wherein the fire-protection system comprises:
a fuel cell with a cathode exhaust gas output which is strictly separated from an anode output, for the provision of an oxygen-reduced cathode exhaust gas with an oxygen content of at the most 15.0% by volume at the cathode exhaust gas output,
a drying system which is connected downstream of the cathode exhaust gas output, for drying the oxygen-reduced cathode exhaust gas before the oxygen-reduced cathode exhaust gas is led into the protective space, and
a control system which is configured to determine a current dew point of the oxygen-reduced cathode exhaust gas which is dried by the drying system and to lead the dried, oxygen-reduced cathode exhaust gas into the protective space only when the current dew point lies below a settable maximal dew point.

In particular, the invention is characterized in that the oxygen-reduced cathode exhaust gas of the fuel cell is firstly dried and the current dew point of the dried, oxygen-reduced cathode exhaust gas then determined. Thereupon, the dried, oxygen-reduced cathode exhaust gas is then only led into the protective space when the current dew point lies below a settable maximal dew point. The controlling of the current dew point of the dried, oxygen-reduced cathode exhaust gas has the advantage that the fire-protection system or fire-protection method according to the invention is independent of the temperature of the dried, oxygen-reduced cathode exhaust gas. For this reason, one can make do without a cooling of the dried, oxygen-reduced cathode exhaust gas independently of the case of application. Given a suitable low dew point, the cathode exhaust gas can have a very much higher temperature than the protective space without introducing too much thermal power into the protective space. For example, given an application for deep-freeze storage, the maximal dew point can be set to −20° C., so that the cathode exhaust gas with a current dew point below −20° C. can be led into the deep-freeze storage space at a temperature of +50° C. or more. The thermal power which is herein introduced by the cathode exhaust gas is negligibly small given such a low current dew point

Optionally, the control system can comprise at least one controllable closure valve, wherein the control system is configured to control the at least one closure valve and to close it to the protective space when the current dew point of the dried, oxygen-reduced cathode exhaust gas is at or above the settable maximal dew point. The closure valve can be opened in the basic state and closed when the current dew point rises above the set maximal dew point. Alternatively to this, the closure valve can have a closed basic state and only open when the current dew point drops below the set maximal dew point.

Optionally, the control system can comprise at least one controllable opening valve, wherein the control system is configured to control the at least one opening valve and only open it to the surroundings when the current dew point of the dried, oxygen-reduced cathode exhaust gas is at or above the settable maximal dew point. It is important for no pressure increase to arise at the cathode exhaust gas output, wherein such a pressure increase could lead to irreparable damage to the fuel cell. For this reason, it is advantageous if the at least one closure valve and/or in particular the at least one opening valve is a rapidly switching magnet valve. In order to prevent a pressure increase at the cathode exhaust gas output, the at least one opening valve can be open, during which or before the at least one closure valve is closed.

Optionally, the at least one closure valve and the at least one opening valve can be separately controllable valves and/or be integrated together into at least one 3/2-way valve.

Optionally, the fire-protection system can comprise at least one safety valve which is arranged upstream of the drying system and opens to the surrounding air in an automatic manner and/or in a manner controlled by the control system, when the pressure of the oxygen-reduced cathode exhaust gas exceeds a maximal value. The safety valve herewith if necessary serves for the protection of the fuel cell from too high a pressure increase at the cathode exhaust gas output. For this, the fire-protection system preferably comprises a pressure sensor which is arranged upstream of the drying system and notifies the control system of the current pressure of the oxygen-reduced cathode exhaust gas.

Optionally, the drying system can be configured to increase a drying power of the drying system when the current dew point of the oxygen-reduced cathode exhaust gas which is dried by the drying system lies at or above the settable maximal dew point. This is particularly expedient if the drying system still has capacities for increasing the drying power and the current dew point still lies relatively far above the set maximal dew point. The drying power of the drying system can be increased for example by way of a further drying stage being connected to this.

Optionally, the drying system can comprise one or more drying stages. In particular, for a use with a deep-freeze storage space as a protective space, several drying stages can be advantageous, in order to bring the current dew point to a correspondingly low value of for example below 31 20° C. A single stage drying system can be adequate for a high-bay storage space which is operated in the range of 10° C. to 30° C.

Optionally, the drying system can comprise an adsorption drier, wherein the adsorption drier can be configured as a rotation dehumidifier with a regeneration air flow which is heated and is opposite to the cathode exhaust gas flow, wherein preferably a heating power for heating the regeneration air flow can be provided at least partly by the waste heat of the fuel cell. In particular, an adsorption drier is particularly advantageous in a second drying stage for the application case of a deep-freeze storage space as a protective space. Specifically, a particularly high degree of drying and a correspondingly lower dew point of for example −20° C. can be achieved with an adsorption drier. It is advantageous to take the heating power for the heating of the regeneration air flow at least partly from the waste heat of the fuel cell, in order to be able to operate the adsorption drier in a particularly efficient manner.

Optionally, all electrical energy which is necessary for the fire protection system can be provided by the fuel cell. By way of this, the fire-protection system can be operated in a completely autarkic manner without connection to an external electricity mains. This is particularly advantageous for mobile protective spaces, for example in the form of a container, trailer or transporter.

Optionally, the fire-protection system can further comprise a fan which is arranged downstream of at least one drying stage of the drying system and is configured to increase the pressure of the oxygen-reduced cathode exhaust gas downstream of the fan. This on the one hand has the advantage that the pressure in the drying stage which is arranged in front is reduced and in a subsequently arranged drying stage or towards the protective space is increased. If for example an adsorption drier is applied as a second drying stage, the increased pressure in the second drying stage ensures that no regeneration air can be sucked into the cathode exhaust gas flow. For this reason, a regeneration air blower is preferably arranged in the regeneration air flow downstream of the adsorption drier, so that the regeneration air blower sucks and does not press the regeneration air into the adsorption drier. By way of this, the pressure of the regeneration air flow in the adsorption drier is reduced, so that by way of this one also prevents regeneration air from being pressed into the cathode exhaust gas.

Optionally, the fire-protection system can comprise a hydrogen catalyzer which is configured to chemically convert residual shares of hydrogen which are located in the dried, oxygen-reduced cathode exhaust gas, before the introduction into the protective space. Herewith, one prevents any residual shares of hydrogen from getting into the protective space.

Preferably, the fuel cell of the fire-protection system is a proton exchange membrane fuel cell (PEMFC). The fuel cell can comprise an anode output which is closed or can be opened. The fuel cell can be operated in a so-called dead-end mode without an anode output or given a closed anode output. The common operating mode of a fuel cell however is a flow-through mode, concerning in which the anode output can be opened, in order when necessary to be able to discharge the fuel which is fed to the anode, for example hydrogen, in order to protect the fuel cell from a harmful anode overpressure and to discharge residual constituents of non-converted fuel. This is effected at regular intervals, depending on the operating state even several times per minute. One also calls this anode fuel purge.

There are fuel cells, concerning which the anode fuel purge is led into the cathode exhaust gas output, thus discharged fuel residual constituents are mixed with the cathode exhaust gas. Such fuel cells cannot be used for the fire-protection system according to the invention. Only a fuel cell, concerning which the cathode exhaust gas output is strictly separated from an anode output, i.e. an anode output is not led together with the cathode exhaust gas output, or there is no anode output at all, can be used for the fire-protection system according to the invention. At all events, an anode fuel purge cannot be effected into the cathode exhaust gas output. The operation of a fuel cell in a dead-end mode is in any case suitable for the fire-protection system according to the invention, since given a closed anode output, no anode fuel purge at all take space and/or the fuel cell does not even comprise an anode output at all. If, despite this, a PEMFC is preferably used for the fire-protection system according to the invention, in principle other types of fuel cells can also be used, such as for example alkaline fuel cells (AFC), phosphoric acid fuel cells (PAFC), molten carbonate fuel cells (MCFC), solid oxide fuel cells (SOFC) or direct alcohol/methanol fuel cells (DAFC/DMFC).

According to a further aspect of the present invention, a mobile or stationary protective space is provided, with a previously described fire-protection system, wherein the protective space is preferably a storage space and/or deep-freeze space which preferably can be at least partly operated with electrical energy which can be provided by the fuel cell. In particular, mobile containers or deep-freeze vehicles with a deep-freeze freight can form such protective spaces. Preferably, the fuel cell provides the complete electrical energy for the operation of the fire-protection system. The thermal energy of the fuel cell which is provided in the form of waste heat can also be utilized by the drying system of the fire-protection system.

According to a further aspect of the present invention, a method is provided for reducing the danger of fire in a protective space, with the steps:
generating an oxygen-reduced cathode exhaust gas which has an oxygen content of at the most 15% by volume, at a cathode exhaust gas output of a fuel cell, wherein the cathode exhaust gas output is strictly separated from an anode output;
drying the oxygen-reduced cathode exhaust gas by way of a drying system which is connected downstream of the cathode exhaust gas output,
determining a current dew point of the dried, oxygen-reduced cathode exhaust gas,
and
leading the dried, oxygen-reduced cathode exhaust gas into the protective space only when the current dew point lies below a settable maximal dew point.

Optionally, the method can further comprise the following steps:
controlling at least one closure valve, and
closing the at least one closure valve to the protective space when the current dew point of the oxygen-reduced cathode exhaust gas which is dried by the drying system lies at or above a settable maximal dew point.

Optionally, the method can further comprise the following steps:
controlling at least one opening valve, and
opening the at least one opening valve to the surroundings when the current dew point of the oxygen-reduced cathode exhaust gas which is dried by the drying system lies at or above the settable maximal dew point. Preferably, the at least one opening valve is firstly opened and the at least one closure valve then closed, when the current dew point lies at or above the settable maximal dew point, in order to avoid an undesirable pressure increase at the cathode exhaust gas output.

Optionally, the method can further comprise an opening of a safety valve when the pressure of the oxygen-reduced cathode exhaust gas downstream of the fuel cell exceeds a maximal value. Herewith, the cathode of the fuel cell can be protected from a harmful excess pressure.

Optionally, the method can further comprise an increasing of the drying power of the drying system when the current dew point of the oxygen-reduced cathode exhaust gas which is dried by the drying system lies at or above the settable maximal dew point. This makes sense, in order to get the current dew point below the maximal dew point more quickly, in order to be able to feed the oxygen-reduced cathode exhaust gas to the protective space more quickly. Preferably, the drying power of the drying system is increased by way of a further drying stage being added.

Preferably, the drying of the method can be effected in one or more drying stages. One drying stage can be sufficient given an application with a storage space in the temperature range of 10° C. to 30° C. Two or more drying stages can be expedient given an application with a deep-freeze storage space as a protective space, concerning which the maximal dew point is set for example to 31 20° C.

Optionally, the drying can be effected in at least one drying stage by way of an adsorption drier which is configured as a rotation dehumidifier, wherein a regeneration air flow which is opposite to the flow of cathode exhaust gas is heated, wherein preferably the waste heat of the fuel cell provides at least a part of the heating power for heating the regeneration air flow. Preferably, the adsorption drier is applied in a second drying stage, in order to lower the current dew point to such an extent that the fire-protection system can be used for the application in a deep-freeze storage space as a protective space, concerning which for example a maximal dew point of −20° C. is set.

Optionally, concerning the method, all necessary energy is provided by the fuel cell. In particular, this makes sense for an application with mobile protective spaces which have no connection to an external electrical energy supply.

Optionally, the method can further comprise an operating of a fan which is arranged downstream of at least one drying stage of the drying system, by which means the pressure of the oxygen-reduced cathode exhaust gas downstream of the fan is increased. This has the advantage that the pressure in a drying stage which is arranged upstream is reduced and in a downstream drying stage and/or towards the protective space is increased. This is particularly useful given an adsorption drier which is arranged downstream and concerning which it must be ensured that no regeneration air is sucked into the cathode exhaust gas flow.

Optionally, residual shares of hydrogen which are situated in the dried, oxygen-reduced cathode exhaust gas can be chemically converted by way of a hydrogen catalyzer before leading the dried, oxygen-reduced cathode exhaust gas into the protective space. This ensures that any residual shares of hydrogen are not led into the protective space.

The method is preferably used with a storage space and/or deep-freeze space as a protective space. One drying stage can be sufficient with regard to a protective space in the form of a storage space with temperatures of for example 10° C. to 30° C. Preferably, two drying stages are used for the application with a deep-freeze space as a protective space.

The invention is hereinafter explained in a more detailed manner by way of the accompanying figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a first part of an embodiment example of a fire-protection system according to the invention;

FIG. 2 is a schematic view showing a first embodiment of a second part of the fire-protection system which connects to the first part of the fire-protection system which is shown in FIG. 1; and

FIG. 3 is a schematic view showing a second embodiment of a second part of the fire-protection system which connects to the first part of the fire-protection system which is shown in FIG. 1.

### DESCRIPTION OF PREFERRED EMBODIMENTS

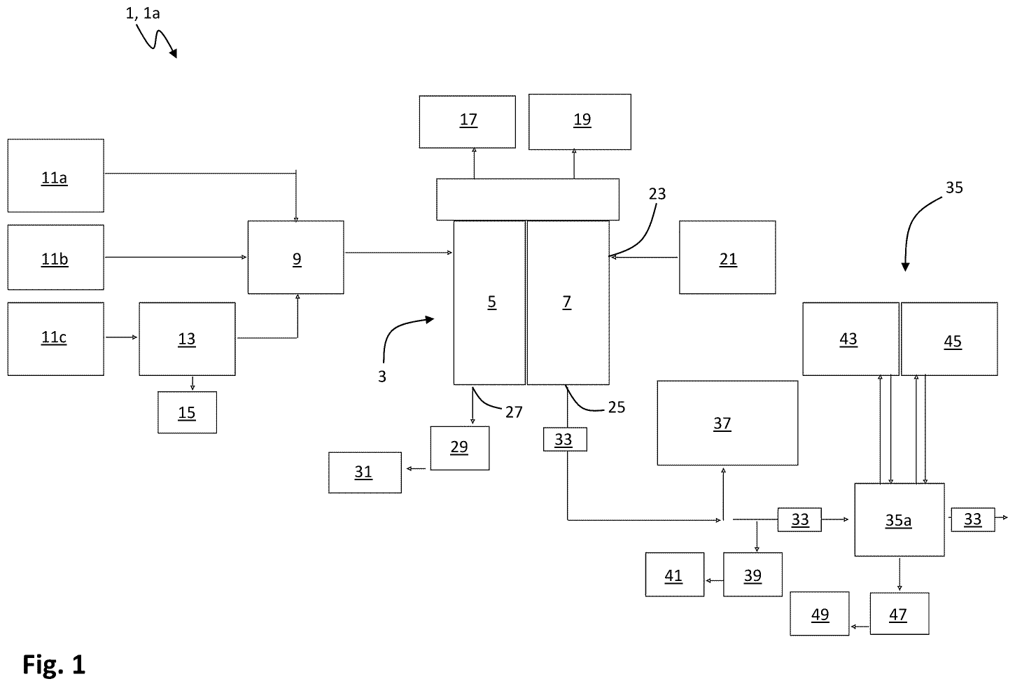

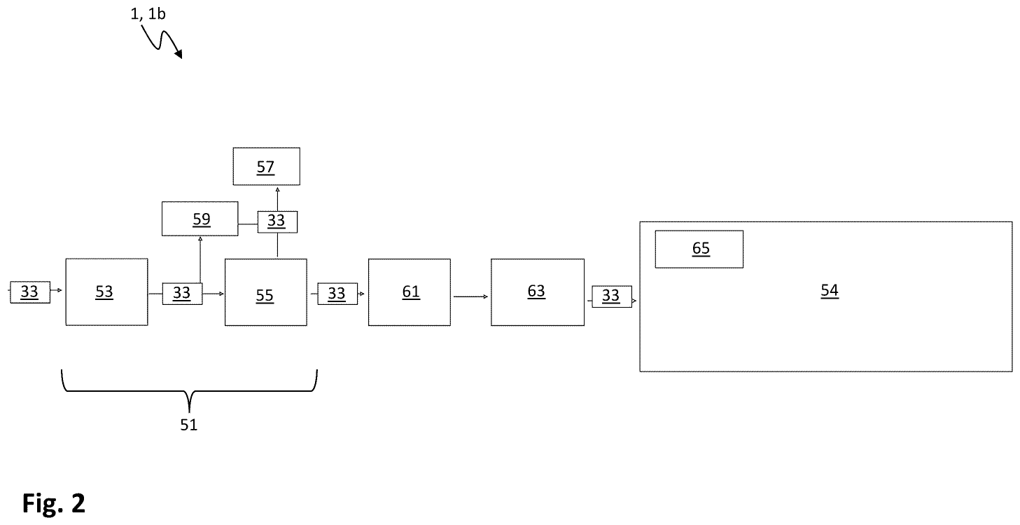

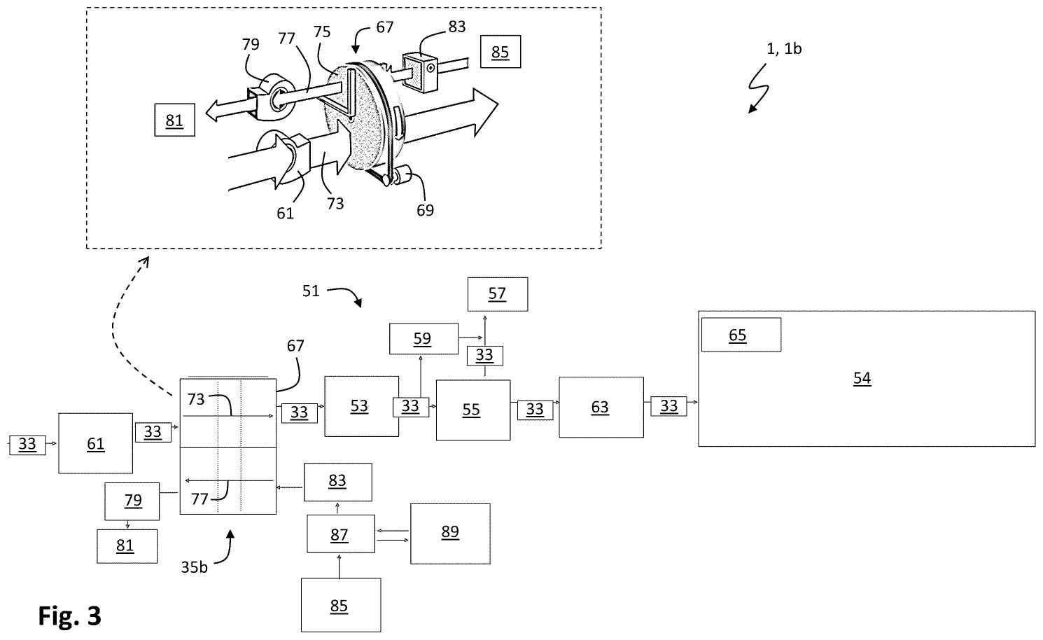

Referring to the drawings, in total, two embodiments of a fire-protection system 1 according to the invention are shown in the figures. A first part la of the fire-protection system 1 is the same for both embodiments and is shown in FIG. 1. The embodiment examples therefore differ only in a second part 1b of the fire-protection system 1, wherein FIG. 2 shows the second part 1b for the first embodiment example and FIG. 3 the second part 1b for the second embodiment example. The two embodiment examples differ essentially in that the first embodiment example according to FIG. 2 comprises a drying system with only one drying stage and the second embodiment example a drying system with two drying stages. The first embodiment example with the single-stage drying preferably serves for the fire protection of storage spaces which are operated for example in a temperature range of 10 ° C.- 30° C. The second embodiment example with a two-stage drying can be used for the fire-protection in deep-freeze storage spaces which are operated in a range below 0° C.

As is shown in FIG. 1, the fire-protection system 1 comprises a fuel cell 3 in the form of a PEMFC. The PEMFC 3 comprises an anode 5 and a cathode 7. The anode 5 of the fuel cell 3 is fed with fuel from a fuel supply 9. The fuel supply 9 here is a hydrogen supply which for its part can be fed with hydrogen as a fuel from one or more fuel sources 11a, 11b, 11c. For example, the fuel source 11a can be a hydrogen store which for example can be filled via an electrolyzer which is installed on location or via delivery or also be completely exchanged. Additionally or alternatively to this, a hydrogen pipeline 11b can serve as a hydrogen source. Alternatively or additionally to this, one can use a methanol store 11c, wherein the methanol can be separated into hydrogen and carbon dioxide in a reformer 13 which is arranged downstream, wherein the carbon dioxide is led away in a carbon dioxide output 15.

On operation of the fuel cell 3, this provides an electrical power 17 and a thermal power 19 in the form of waste heat. The cathode 7 of the fuel cell 3 comprises a cathode entry 23, via which the cathode 7 can be fed with surrounding air 21. Moreover, the cathode 7 comprises a cathode exhaust gas output 25, at which oxygen-reduced cathode exhaust gas with an oxygen content of at the most 15% by volume is led away at the cathode exhaust gas output 25. In the shown embodiment, the anode 5 also comprises an output 27 which however is strictly separated from the cathode exhaust gas output 25, i.e. is not led together. The anode exhaust gas output 27 serves for a hydrogen purge 29 in a flow-through operating mode, said hydrogen purge possibly being necessary in order to protect the anode 5 from an excess pressure of hydrogen and to discharge hydrogen residual constituents. The hydrogen can then be dissipated into the surroundings 31. However, with regard to the fire-protection system 1 according to the invention, it is however essential that the hydrogen is not led into the exhaust gas conduit 33 of the cathode 7, but for the cathode exhaust gas output 25 to be strictly separated from the anode exhaust gas output 27.

The oxygen-reduced cathode exhaust gas is fed via conduits 33 to a drying system 33 which is connected downstream of the cathode exhaust gas output 25, said drying system being for drying the oxygen-reduced cathode exhaust gas. A first drying stage 35a of the drying system is shown in FIG. 1. A safety valve 37 which opens to the surrounding air automatically and/or in a controlled manner when the pressure of the oxygen-reduced cathode exhaust gas at the cathode exhaust gas output 25 exceeds a maximal value is arranged upstream of the first drying stage 35a of the drying system 35. Since the cathode exhaust gas can already contain water in droplet form, this can be led away via a water discharge 39 and a siphon 41 even before the first drying stage 35a of the drying system 35.

The first drying stage 35a here is operated via an open-air cooler 43 and/or a water chiller 45, wherein water 47 is taken from the cathode exhaust gas and runs off via a siphon. 49. The oxygen-reduced cathode exhaust gas which is dried in the first drying stage 35a is then led to the second part 1b of the fire-protection system 1 via the conduit system 33.

In the first embodiment of the second part 1b of the fire-protection system 1 which is shown in FIG. 2, the drying system 35 has no further drying stage. The oxygen-reduced cathode exhaust gas which is dried in the single drying stage 35a of the drying system 35 here is fed to a control system 51 which is arranged after the drying system 35. The control system 51 is configured, by way of a dew point sensor 53, to determine the current dew point of the oxygen-reduced cathode exhaust gas which is dried by the drying system 35 and to only let the dried, oxygen-reduced cathode exhaust gas through to the protective space 54 when the current dew point lies below a settable maximal dew point. For this, the control system 51 comprises a controllable closure valve 55 in the form of a 3/2 way valve which can be controlled to close the cathode exhaust gas flow towards the protective space 54 and to discharge the cathode exhaust gas to the surroundings 57. Since the 3/2-way valve 55 possibly cannot open or close rapidly enough, an opening valve 59 in the form of a rapidly switchable magnet valve is provided in the control system 51, in order to rapidly open the flow of cathode exhaust gas to the surroundings 57, before an excess pressure arises in the cathode exhaust gas conduit 33 due to the closure of the closure valve 55, said excess pressure capable of causing damage to the cathode 7 of the fuel cell 3.

If the dried, oxygen-reduced cathode exhaust gas has a sufficiently low dew point, then the closure valve 55 is either open or is opened and a fan 61 which is arranged downstream presses the dried, oxygen-reduced cathode exhaust gas into the protective space 54. An optional hydrogen catalyzer 63 is yet intermediately arranged here between the fan 61 and the protective space 54 and is configured to chemically convert residual shares of hydrogen which are located in the dried, oxygen-reduced cathode exhaust gas, before the introduction into the protective space 54.

A monitoring system 65 which monitors the atmosphere in the protective space 54 is located in the protective space 54. The monitoring system 65 can for example measure the oxygen concentration, the nitrogen concentration and/or the carbon dioxide concentration of the atmosphere in the protective space 54 and closed-loop control the feed of dried, oxygen-reduced cathode exhaust gas. By way of this, one can continuously maintain a desired oxygen concentration in the atmosphere of the protective space 54. Preferably, the fire-protection system 1 as a whole is only operated when required, such being activated by the monitoring system 65. The fire protection system 1 can be idle for as long as an adequately low oxygen content is situated in the atmosphere of the protective space 54. Alternatively to this, the fuel cell 3 of the fire-protection system 1 can be operated for providing an electrical power and/or thermal power when no cathode exhaust gas is necessary for the fire protection. The cathode exhaust gas is then simply dissipated to the surroundings 57. In the embodiment which is shown in FIG. 2, the protective space 54 is preferably a storage space which is operated in the temperature range of 10° C. to 30° C.

FIG. 3 shows a second embodiment example, concerning which the second part 1b of the fire-protection system 1 comprises a second drying stage 35b of the drying system, 35. The protective space 54 here is a deep-freeze storage space which is operated at temperatures below the freezing point of water. Downstream of the second drying stage 35b, the embodiment example which is shown in FIG. 3 is identical to the first embodiment example which is shown in FIG. 2, with the exception of the position of the fan 61. The fan 61 here is specifically connected between the first drying stage 35a and the second drying stage 35b.

The second drying stage 35b of the drying system 35 here comprises an adsorption drier 67 in the form of a rotation dehumidifier whose manner of functioning is illustrated in the dashed box of FIG. 3. The rotation dehumidifier 67 is driven into rotation by a motor 69. The fan 61 presses the oxygen-reduced cathode exhaust gas which is pre-dried in the first drying stage 35a, as a cathode exhaust gas flow 73, axially through the rotating rotation dehumidifier 67. In the rotation dehumidifier, the cathode exhaust gas releases moisture onto the inner surfaces of the rotation dehumidifier 67 by way of adsorption. The inner surfaces of the rotation dehumidifier 67 are dried by a regeneration air flow 77 in a segment 75 of the rotation dehumidifier 67 which is sealingly separated from the cathode exhaust gas flow 73. The regeneration air flow 77 is opposite to the cathode exhaust gas flow and is sucked into the rotation dehumidifier 67 by way of a regeneration air blower 79. The humidified regeneration air is then released to the surroundings 81. The regeneration air is heated or pre-heated by way of a heater 83 before the entry into the rotation dehumidifier 67 in order to increase the drying power of the adsorption drier 67. Additionally or alternatively to the heater 83, the thermal power 19 of the fuel cell 77 can be at least partly used for heating the regeneration air flow 77. For a further increase of the drying power, the regeneration air which is taken from the environment 85 can be dried in a drier 87 by way of a water chiller 89 before it is heated in the heater 83 and/or is heated by way of the waste heat 19 of the fuel cell 3.

On account of the upstream arrangement of the fan 61 in the cathode exhaust gas flow with respect to the rotation dehumidifier 67 and the downstream arrangement of the regeneration air blower 79 in the regeneration air flow with respect to the rotation dehumidifier 67, it is ensured that a higher pressure exists in the cathode exhaust gas flow 73 than in the regeneration air flow 77, so that no regeneration air can get through any unsealed locations in the cathode exhaust gas flow 73.

On account of the second drying stage 35b, the cathode exhaust gas can be dried to such an extent that the current dew point can lie for example below a set −20° C. which can be controlled by the dew point sensor 53 of the control system 51. On account of the low dew point, the cathode exhaust gas only caries a very low quantity of heat even if the temperature of the cathode exhaust gas can be 50° C. or more. On account of this, a feeding of the relatively hot, but very dry cathode exhaust gas flow into the deep-freeze storage space 54 does not lead to a high input of heat into the deep-freeze storage space 54. A cooling of the cathode exhaust gas flow is not therefore necessary. The functioning manner of the control system 51 in the second embodiment example which is shown in FIG. 3 is identical to the aforementioned functioning manner of the control system 51 in the first embodiment example according to FIG. 2.

While specific embodiments of the invention have been shown and described in detail to

5 illustrate the application of the principles of the invention, it will be understood that the invention may be embodied otherwise without departing from such principles.

### LIST OF REFERENCE NUMERALS

1 fire protection system
1a first part of the fire-protection system
1b second part of the fire-protection system
3 fuel cell
5 anode
7 cathode
9 fuel feed
11a hydrogen store
11b hydrogen pipeline
11c methanol store
13 reformer
15 carbon dioxide output
17 electrical power
19 thermal power
21 surrounding air
23 cathode entry
25 cathode exhaust gas output
27 anode exhaust gas output
29 hydrogen purge
31 surroundings
33 cathode exhaust gas conduit
35 drying system
35a first drying stage
35b second drying stage
37 safety valve
39 water outlet
41 siphon
43 open-air cooler
45 water chiller
47 water
49 siphon
51 control system
53 dew point sensor
54 protective space
55 closure valve
57 surroundings
59 opening valve
61 fan
63 hydrogen catalyzer
65 monitoring system
67 adsorption drier/rotation dehumidifier
69 motor
73 cathode exhaust gas flow
75 segment of the rotation dehumidifier
77 regeneration air flow
79 regeneration air blower
81 surroundings
83 heater
85 surrounding air
87 drier
89 water chiller

What is claimed is:

1. A fire-protection system for a reduction of a danger of fire in a protective space, the fire-protection system comprising:
a fuel cell with a cathode exhaust gas output, which is strictly separated from an anode output, configured to provide an oxygen-reduced cathode exhaust gas with an oxygen content of at the most 15.0% by volume at the cathode exhaust gas output;
a drying system connected downstream of the cathode exhaust gas output and configured for drying the oxygen-reduced cathode exhaust gas before the oxygen-reduced cathode exhaust gas is led into the protective space; and
a control system configured to determine a current dew point of the oxygen-reduced cathode exhaust gas which is dried by the drying system and to lead the dried, oxygen-reduced cathode exhaust gas into the protective space only when the current dew point lies below a settable maximal dew point.

2. A fire-protection system according to claim 1, wherein the control system further comprises at least one controllable closure valve, wherein the control system is configured to control the at least one closure valve and to close the at least one closure valve to the protective space when the current dew point of the oxygen-reduced cathode exhaust gas which is dried by) the drying system is at or above the settable maximal dew point.

3. A fire-protection system according to claim 1, wherein the control system comprises at least one controllable opening valve, wherein the control system is configured to control the at least one opening valve and to open the at least one opening valve to surroundings when the current dew point of oxygen-reduced cathode exhaust gas which is dried by the drying system is at or above the settable maximal dew point.

4. A fire-protection system according to claim 2,
wherein the control system comprises at least one controllable opening valve, wherein the control system is configured to control the at least one opening valve and to open the at least one opening valve to surroundings when the current dew point of oxygen-reduced cathode exhaust gas which is dried by the drying system is at or above the settable maximal dew point, and
wherein the at least one closure valve and the at least one opening valve are separately controllable valves and/or integrated into at least one 3/2-way valve.

5. A fire-protection system according to claim 1, further comprising at least one safety valve which is arranged upstream of the drying system and opens to surrounding air in an automatic manner and/or in a manner controlled by the control system, when the pressure of the oxygen-reduced cathode exhaust gas exceeds a maximal value.

6. A fire-protection system according to claim 1, wherein the drying system is configured to increase a drying power of the drying system when the current dew point of the oxygen-reduced cathode exhaust gas which is dried by the drying system lies at or above the settable maximal dew point.

7. A fire-protection system according to claim 1, wherein the drying system comprises one or more drying stages.

8. A fire-protection system according to claim 1, wherein the drying system comprises an adsorption drier, wherein the adsorption drier is configured as a rotation dehumidifier configured a regeneration air flow which is heated and is opposite to the cathode exhaust gas flow, and wherein a heating power for heating the regeneration air flow is provided at least partly by the waste heat of the fuel cell.

9. A fire-protection system according to claim 1, wherein the system is configured such that electrical energy for the fire protection system is provided by the fuel cell.

10. A fire-protection system according to claim 1, further comprising a fan which is arranged downstream of at least one drying stage of the drying system and which is configured to increase a pressure of the oxygen-reduced cathode exhaust gas downstream of the fan.

11. A fire-protection system according to claim 1, further comprising a hydrogen catalyzer which is configured to chemically convert residual shares of hydrogen which are located in the dried, oxygen-reduced cathode exhaust gas, before the introduction into the protective space.

12. A fire-protection system according to claim 1, wherein the fuel cell is configured as a proton exchange membrane fuel cell.

13. A mobile or stationary protective space in combination with a fire-protection system according to claim 1, wherein the protective space comprises a storage space and/or a deep-freeze space which is configured to be at least partly operated with electrical energy which can be provided by the fuel cell.

14. A method for reducing a danger of fire in a protective space, the method comprising the steps of:
generating an oxygen-reduced cathode exhaust gas which has an oxygen content of at the most 15% by volume, at a cathode exhaust gas output of a fuel cell, wherein the cathode exhaust gas output is strictly separated from an anode output;
drying the oxygen-reduced cathode exhaust gas by way of a drying system which is connected downstream of the cathode exhaust gas output;
determining a current dew point of the dried, oxygen-reduced cathode exhaust gas; and
leading the dried, oxygen-reduced cathode exhaust gas into the protective space only when the current dew point lies below a settable maximal dew point.

15. A method according to claim 14, further comprising the steps of:
controlling at least one closure valve; and
closing the at least one closure valve to the protective space when the current dew point of the oxygen-reduced cathode exhaust gas which is dried by the drying system lies at or above the settable maximal dew point.

16. A method according to claim 14, comprising the steps of:
controlling at least one opening valve; and
opening the at least one opening valve to surroundings when the current dew point of the oxygen-reduced cathode exhaust gas which is dried by the drying system lies at or above the settable maximal dew point.

17. A method according to claim 14, further comprising opening a safety valve when the pressure of the oxygen-reduced cathode exhaust gas downstream of the fuel cell exceeds a maximal value.

18. A method according to claim 14, further comprising increasing a drying power of the drying system when the current dew point of the oxygen-reduced cathode exhaust gas which is dried by the drying system lies at or above the settable maximal dew point.

19. A method according to claim 14, wherein the drying is effected in one or more drying stages.

20. A method according to claim 14, wherein the drying is effected in at least one drying stage by an adsorption drier which is configured as a rotation dehumidifier, wherein a regeneration air flow which is opposite to the cathode exhaust gas flow is heated, wherein preferably waste heat of the fuel cell provides at least a part of the heating power for heating the regeneration air flow.

21. A method according to claim 14, wherein all electrical energy which is necessary for the method is provided by the fuel cell.

22. A method according to claim 14, further comprising the step of operating a fan which is arranged downstream of at least one drying stage of the drying system, by which means the pressure of the oxygen-reduced cathode exhaust gas downstream of the fan is increased.

23. A method according to claim 14, wherein residual shares of hydrogen which are situated in the dried, oxygen-reduced cathode exhaust gas are chemically converted by way of a hydrogen catalyzer before leading the dried, oxygen-reduced cathode exhaust gas into the protective space.

24. A method according to claim 14, wherein the protective space is a storage space and/or a deep-freeze space.
